(19) United States
(12) Patent Application Publication
(10) Pub. No.: US 2012/0294514 A1
(43) Pub. Date: Nov. 22, 2012

(54) TECHNIQUES TO ENABLE AUTOMATED WORKFLOWS FOR THE CREATION OF USER-CUSTOMIZED PHOTOBOOKS

(75) Inventors: Craig John Saunders, Grenoble (FR); Luca Marchesotti, Grenoble (FR); Julianna Elizabeth Lin, Rochester, NY (US); Robert J. Rolleston, Rochester, NY (US); Thomas L. Maloney, Webster, NY (US)

(73) Assignee: Xerox Corporation, Norwalk, CT (US)

(21) Appl. No.: 13/111,060

(22) Filed: May 19, 2011

(51) Int. Cl. G06K 9/62; G06K 9/68; G06K 9/46; G06K 9/36; G06K 9/00

(52) U.S. Cl. 382/159; 382/284; 382/165; 382/195; 382/218; 382/282

(57) ABSTRACT

A system and method for generating a photobook are provided. The method includes receiving a set of images and automatically selecting a subset of the images as candidates for inclusion in a photobook. At least one design element of a design template for the photobook is automatically selected, based on information extracted from at least one of the images in the subset. Placeholders of the design template are automatically filled with images drawn from the subset to form at least one page of a multipage photobook. The exemplary system and method address some of the problems of photobook creation, thorough combining automatic methods for selecting, cropping, and placing photographs into a photo album template, which the user can then post-edit, if desired. This can greatly reduce the time required to create a photobook and thus encourage users to print photo albums.

### BACKGROUND

The exemplary embodiment relates to image processing. It finds particular application in connection with the creation of photobooks and will be described with reference thereto.

There is a growing market for photobooks. These are assembled collections of photographs in hardcopy form that are customized for displaying a user's photographs. When creating photobooks from image collections, users often manually select photographs for creating the photobook. However, this step, along with the layout and customization steps, can be very time-consuming for the user. As a consequence, photobooks started online are often never finished and thus the revenue which a service provider could generate is often not realized.

Currently, several photo-printing companies provide methods for creating automatic layouts. However, these techniques still lead to many issues with the final photobook. For example, there is often a lack of consistency between photographs and the results are often unattractive, even when basic color histogram information is used. These issues reduce the quality and consistency of automated photobook creation and reduce the usefulness of such methods.

The exemplary embodiment provides a system and method for creation of photobooks which can reduce the need for manual editing while yielding a more attractive product than is conventionally available.

### INCORPORATION BY REFERENCE

The following references, the disclosures of which are incorporated herein by reference in their entireties, are mentioned.

Methods for extracting a region of interest in an image are disclosed, for example, in U.S. Pub. No. 20100226564, published Sep. 9, 2010, entitled A FRAMEWORK FOR IMAGE THUMBNAILING BASED ON VISUAL SIMILARITY, by Luca Marchesotti, et al., and U.S. Pub. No. 20100091330, published Apr. 15, 2010, entitled IMAGE SUMMARIZATION BY A LEARNING APPROACH, by Luca Marchesotti, et al.

The following references relate generally to visual classification and image retrieval methods: US Pub. No. 20030021481, published Jan. 30, 2003, entitled IMAGE RETRIEVAL APPARATUS AND IMAGE RETRIEVING METHOD, by E. Kasutani; U.S. Pub. No. 2007005356, published Jan. 4, 2007, entitled GENERIC VISUAL CATEGORIZATION METHOD AND SYSTEM, by Florent Perronnin; U.S. Pub. No. 20070258648, published Nov. 8, 2007, entitled GENERIC VISUAL CLASSIFICATION WITH GRADIENT COMPONENTS-BASED DIMENSIONALITY ENHANCEMENT, by Florent Perronnin; U.S. Pub. No. 20080069456, published Mar. 20, 2008, entitled BAGS OF VISUAL CONTEXT-DEPENDENT WORDS FOR GENERIC VISUAL CATEGORIZATION, by Florent Perronnin; U.S. Pub. No. 20080317358, published Dec. 25, 2008, entitled CLASS-BASED IMAGE ENHANCEMENT SYSTEM, by Marco Bressan, et al.; U.S. Pub. No. 20090144033, published Jun. 4, 2009, entitled OBJECT COMPARISON, RETRIEVAL, AND CATEGORIZATION METHODS AND APPARATUSES, by Yan Liu, et al.; U.S. Pub. No. 20100040285, published Feb. 18, 2010, entitled SYSTEM AND METHOD FOR OBJECT CLASS LOCALIZATION AND SEMANTIC CLASS BASED IMAGE SEGMENTATION, by Gabriela Csurka, et al.; U.S. Pub. No. 20100092084, published Apr. 15, 2010, entitled REPRESENTING DOCUMENTS WITH RUNLENGTH HISTOGRAMS, by Florent Perronnin, et al.; U.S. Pub. No. 20100098343, published Apr. 22, 2010, entitled MODELING IMAGES AS MIXTURES OF IMAGE MODELS, by Florent Perronnin, et al.; U.S. Pub. No. 20100189354, published Jul. 29, 2010, entitled MODELING IMAGES AS SETS OF WEIGHTED FEATURES, by Teofilo E. de Campos, et al.; U.S. Pub. No. 20100318477, published Dec. 16, 2010, entitled FAST AND EFFICIENT NONLINEAR CLASSIFIER GENERATED FROM A TRAINED LINEAR CLASSIFIER, by Florent Perronnin, et al., U.S. Pub. No. 20110040711, published Feb. 17, 2011, entitled TRAINING A CLASSIFIER BY DIMENSION-WISE EMBEDDING OF TRAINING DATA, by Florent Perronnin, et al.; U.S. application Ser. No. 12/512,209, filed Jul. 30, 2009, entitled COMPACT SIGNATURE FOR UNORDERED VECTOR SETS WITH APPLICATION TO IMAGE RETRIEVAL, by Florent Perronnin, et al.; U.S. patent application Ser. No. 12/693,795, filed on Jan. 26, 2010, entitled A SYSTEM FOR CREATIVE IMAGE NAVIGATION AND EXPLORATION, by Sandra Skaff, et al.; U.S. application Ser. No. 12/859,898, filed on Aug. 20, 2010, entitled LARGE SCALE IMAGE CLASSIFICATION, by Florent Perronnin, et al.; Perronnin, F., Dance, C., “Fisher Kernels on Visual Vocabularies for Image Categorization,” in Proc. of the IEEE Conf on Computer Vision and Pattern Recognition (CVPR), Minneapolis, Minn., USA (June 2007); Yan-Tao Zheng, Ming Zhao, Yang Song, H. Adam, U. Buddemeier, A. Bissacco, F. Brucher, Tat-Seng Chua, and H. Neven, “Tour the World: Building a web-scale landmark recognition engine,” IEEE Computer Society Conference, 2009; Herve Jegou, Matthijs Douze, and Cordelia Schmid, “Improving Bag-Of-Features for Large Scale Image Search,” in IJCV, 2010; G. Csurka, C. Dance, L. Fan, J. Willamowski and C. Bray, “Visual Categorization with Bags of Keypoints,” ECCV Workshop on Statistical Learning in Computer Vision, 2004; Herve Jegou, Matthijs Douze, and Cordelia Schmid, “Hamming embedding and weak geometric consistency for large scale image search,” in ECCV 2008; Jorma Laaksonen, Markus Koskela, and Erkki Oja, “PicSOM self-organizing image retrieval with MPEG-7 content descriptions,” IEEE Transactions on Neural Networks, vol. 13, no. 4, 2002; and Perronnin, J. Sanchez, and T. Mensink, “Improving the fisher kernel for large-scale image classification,” in ECCV 2010, the disclosures of all of which are incorporated herein in their entireties by reference.

U.S. Pub. No. 2009/0208118, published Aug. 20, 2009, entitled CONTEXT DEPENDENT INTELLIGENT THUMBNAIL IMAGES, by Gabriela Csurka, discloses an apparatus and method for context dependent cropping of a source image.

Methods for determining aspects of image quality and for image enhancement are described, for example, in U.S. Pat. Nos. 5,357,352, 5,363,209, 5,371,615, 5,414,538, 5,450,217; 5,450,502, 5,802,214 to Eschbach, et al., U.S. Pat. No. 5,347,374 to Fuss, et al., U.S. Pub. No. 20030081842 to Buckley, U.S. Pub. No. 20080317358, entitled CLASS-BASED IMAGE ENHANCEMENT SYSTEM Dec. 25, 2008 by Marco Bressan, et al.; U.S. Pub. No. 20080278744, published Nov. 13, 2008, entitled PRINT JOB AESTHETICS ENHANCEMENTS DETECTION AND MODELING THROUGH COMBINED USER ACTIVITY ANALYSIS AND CONTENT MATCHING, by Luca Marchesotti, et al.

Photo album-related techniques are disclosed in U.S. Pat. No. 7,188,310, entitled AUTOMATIC LAYOUT GENERATION FOR PHOTOBOOKS, issued Mar. 6, 2007, by Schwartzkopf; U.S. Pat. No. 7,711,211, issued May 4, 2010, entitled METHOD FOR ASSEMBLING A COLLECTION OF DIGITAL IMAGES, by Snowdon, et al.; U.S. Pub. No. 20020122067, published Sep. 5, 2002, entitled SYSTEM AND METHOD FOR AUTOMATIC LAYOUT OF IMAGES IN DIGITAL ALBUMS, by Geigel, et al.; U.S. Pub. No. 20090024914, entitled FLEXIBLE METHODS FOR CREATING PHOTOBOOKS, published Jan. 22, 2009, by Chen, et al.; U.S. Pub No. 20090232409, published Sep. 17, 2009, entitled AUTOMATIC GENERATION OF A PHOTO GUIDE, by Luca Marchesotti, et al.; U.S. Pub. No. 20090254830, entitled DIGITAL IMAGE ALBUMS, published Oct. 8, 2009, by Reid, et al.; U.S. Pub. No. 20100073396, entitled SMART PHOTOBOOK CREATION, published Mar. 25, 2010, by Wang.

Methods for computing a user profile based on images in the user's collection are disclose, for example, in U.S. application Ser. No. 13/050,587, filed on Mar. 17, 2011, entitled SYSTEM AND METHOD FOR ADVERTISING USING IMAGE SEARCH AND CLASSIFICATION, by Craig Saunders, et al.

### BRIEF DESCRIPTION

In accordance with one aspect of the exemplary embodiment, a method of generating a photobook includes receiving a set of images and automatically selecting a subset of the images as candidates for inclusion in a photobook. At least one design element of a design template is automatically selected for the photobook based on information extracted from at least one of the images in the subset. Placeholders of the design template are automatically filled with images from the subset to form a page of a multipage photobook.

In accordance with another aspect of the exemplary embodiment, a system for generating a photobook includes a selection component for automatically selecting a subset of a set of images as candidates for inclusion in a photobook, a template component for automatically selecting at least one design element of design template for the photobook based on information extracted from at least one of the images in the subset, and a creation component which automatically fills placeholders of the design template with images from the subset to form a multipage photobook. A processor implements the selection component, template component, and creation component.

In accordance with another aspect, a workflow process includes automatically selecting a subset of a set of input images based on at least one of a computation of image quality and a computation of near duplicate images, automatically cropping at least some of images in the subset based on identification of a salient region of the respective image, grouping similar images in the subset into groups based on a computation of at least one of structural similarity, content similarity, and aesthetic similarity, automatically selecting at least one design element of design template for a page of a book based on information extracted from at least one of the images in one of the groups, the design element being selected from a border color, a border pattern, a background color, a background pattern, and a font color for the page. Placeholders of the design template are automatically filled with the group of images to form a page.

### BRIEF DESCRIPTION OF THE DRAWINGS

FIG. 1 is a flow diagram of an exemplary method for creation of a photobook in accordance with one aspect of the exemplary embodiment;

FIG. 2 is a functional block diagram of an exemplary system for creation of a photobook;

FIG. 3 illustrates the automatic filling of a template with an anchor image and a set of supporting images during creation of a photobook;

FIG. 4 illustrates automated saliency detection where, given an image to thumbnail, the K most similar images are retrieved and a classifier is trained on these images to detect salient (foreground) and non-salient (background) regions from which saliency maps are generated and thumbnails (cropped regions forming less than the entire image) are extracted;

FIG. 5 illustrates the results of applying different similarity metrics for clustering images: (a) structure, (b) content, and (c) aesthetic affinity;

FIG. 6 illustrates one specific workflow in accordance with the exemplary embodiment, illustrating an interactive mode.

### DETAILED DESCRIPTION

The term “photobook” refers to books that include one or more pages and at least one image on a book page. Exemplary photobooks can include a photo album, a scrapbook, a photo calendar, combination thereof, or the like.

A user can be any person participating in the generation of a photobook, such as a customer, photographer, designer, service provider, or the like. User-customized means that the photobook is specific to a particular user, such as to a recipient, creator, or to an event.

Aspects of the exemplary embodiment relate to a system and method for generating a digital photobook (e.g., a photo album) from a set of images which allows for minimal interaction from a user. Various computer vision tools are used to help to overcome problems related to the creation of photograph albums that have not been previously considered, such as one or more of poor consistency and flow between photos, poor harmonization of design elements within a page layout, and poor choice of photograph content (e.g., presence of duplicates, poorly cropped images, blurry images, and the like). In the exemplary embodiment, an automated workflow for photobook creation is handled in two stages: A) the large pool of input images is evaluated using image quality metrics and by the removal of near duplicates to generate a smaller pool of images, and B) the smaller pool of input images (e.g., which all meet a minimum quality standard) is then analyzed to determine how the images should be arranged in the photobook.

The system and method may thus employ image processing techniques for determining the quality of images and to identify automatically those that can be discarded (e.g., due to blur, noise, low resolution, poor contrast, overexposure, or the like). In various embodiments, an automatic method is used to detect the salient regions of the image and to perform auto-cropping, as appropriate. Image clustering techniques may be used to identify near duplicates. Image classification techniques may be used to help users create themes within their photobooks, leading to more consistent and higher quality photobooks. To provide better consistency between photographs, color palettes extracted from images can be used to harmonize the choice of photos within a page. Similarly, color palettes can also be used to harmonize other design elements (e.g., borders, fonts, background colors, and the like).

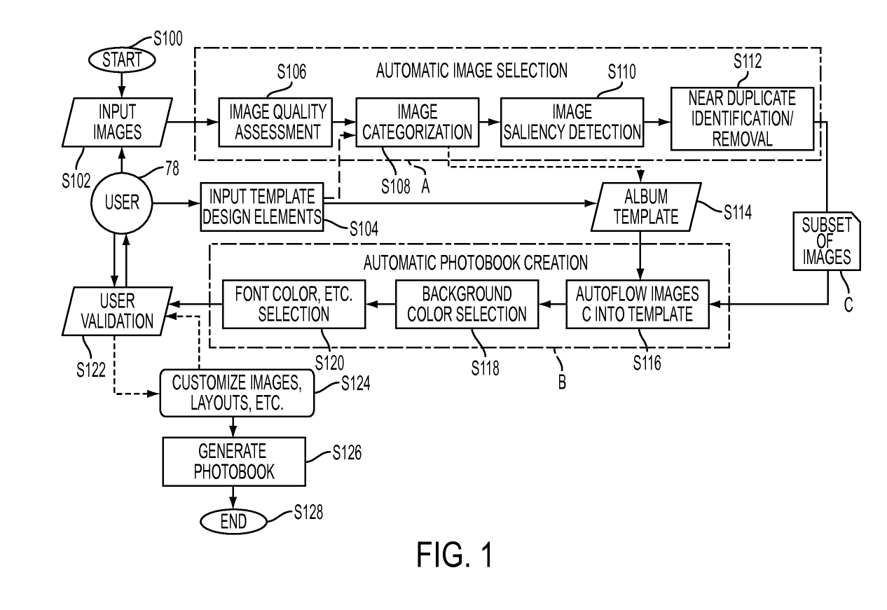

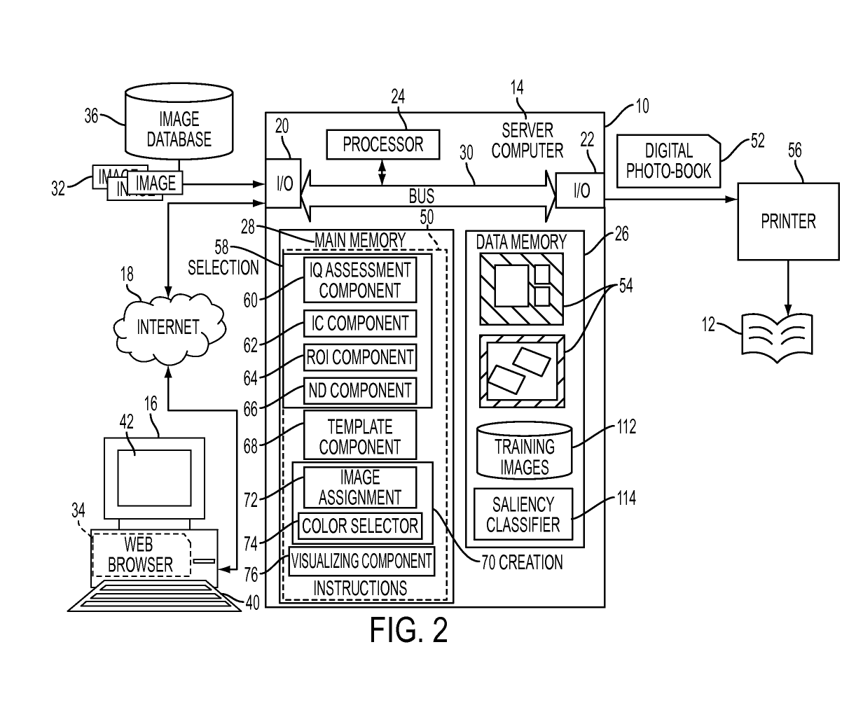

FIGS. 1 and 2 illustrate an exemplary method and system 10 for automated or semi-automated creation of a photobook 12. As shown in FIG. 1, the system includes a computing device, such as the illustrated server computer 14 which receives a request for creation of a photobook from a client device 16, via a wired or wireless link 18, such as the Internet. The exemplary server computer includes one or more input/output devices (I/O) 20, 22, a processor 24, and memory 26, 28 which communicate via one or more data/control buses 30. The server computer 14 may host a website with a public portal which allows users working on remote client devices 16 to upload images 32 to the computer using a web browser 34 on the respective client device. The images 32 may be stored a database 36, in data memory 26 of the server computer 14 and/or in memory accessible to the server 14, e.g., via a wired or wireless connection.

The client device 16 enables a user 38 (FIG. 1) to interact with the server computer 14 via one or more user input devices 40, such as a touch screen, keyboard, keypad, cursor control device, or the like and to view images on a display device 42, such as an LCD screen. The displayed images may be stored locally or remotely, e.g., in database 36.

The system 10 stores instructions 50 in main memory 28 for generating a digital photobook 52, based on images 32 selected by the user. A part of the instructions may be resident on the client device 16 or accessible thereto for selection of various options and images 32 for the photobook. A set of templates/template elements 54 for use in creation of the photobook is stored in memory 26. The digital photobook 52, e.g., as a data file, may also be stored in data memory 26 during creation, and output in digital form to client device 16, and/or output to a rendering device 56. The rendering device 56 may include a printer, which applies the images to print media, such as photo-quality paper using colorants, such as inks, toners, or the like or uses other hardcopy rendering techniques, and assembles the printed pages to form a multi-page photobook 12.

The exemplary instructions 50 include a set of processing components including a selection component 58 (including an image quality (IQ) assessment component 60, an image categorization (IC) component 62, a region of interest (ROI) detection component 64, a near duplicate (ND) detection and removal component 66, a template retriever 68, a creation component 70 (including an image assignment component 72 and a color selection component 74), and a visualizing component 76. It is to be appreciated that the components may be in the form of hardware or a combination of hardware and software and may be separate or combined into fewer more or different components. The illustrated components are in the form of software instructions which are executed by processor 24. In some embodiments, the instructions may be partially or wholly resident on client device 16. The components 58, 60, 62, 64, 66, 68, 70, 72, 74, 76 are best understood in connection with the method described with reference to FIG. 1.

The computer(s) 14, 16 may each include one or more general or specific purpose computers, such as a PC, such as a desktop, a laptop, palmtop computer, portable digital assistant (PDA), digital camera, server computer, cellular telephone, tablet computer, pager, or other computing device(s) capable of executing instructions for performing the exemplary method.

The digital processor 24 can be variously embodied, such as by a single-core processor, a dual-core processor (or more generally by a multiple-core processor), a digital processor and cooperating math coprocessor, a digital controller, or the like. In general, any device, capable of implementing a finite state machine that is in turn capable of implementing the flowchart shown in FIG. 2, can be used as the processor.

The memory or memories 26, 28 may represent any type of non-transitory computer readable medium such as random access memory (RAM), read only memory (ROM), magnetic disk or tape, optical disk, flash memory, or holographic memory. In one embodiment, the memory 26, 28 comprises a combination of random access memory and read only memory. Memory 28 may store instructions for the operation of server computer as well as for performing the exemplary method described below. Memory 26 stores images 32 being processed by the exemplary method as well as the processed data 52. Client device may be similarly configured with hardware analogous to hardware 20, 22, 24, 26, 28, 30 of computer 14 and will not be described further.

The network interface 20, 22 may comprise a modulator/demodulator (MODEM) and allows the computer to communicate with other devices via a wired or wireless links 72, such as computer network, e.g., a local area network (LAN), wide area network (WAN), such as the Internet, telephone line, wired connection, or a combination thereof.

A set of images 32 to be processed is input to the system 10 from any suitable source of images, such as a general purpose or specific purpose computing device, such as a PC, laptop, camera, cell phone, or the like, or from a non-transitory memory storage device, such as a flash drive, disk, portable hard drive, camera memory stick, or the like. In the exemplary embodiment, the client computing device web browser can be used for uploading images to a web portal hosted by the server computer 14. Images may be received by the system in any convenient file format, such as JPEG, GIF, JBIG, BMP, TIFF, or the like or other common file format used for images and which may optionally be converted to another suitable format prior to processing. Input images may be stored in data memory during processing. The input images 32 may be individual images, such as photographs, video images, or combined images which include photographs along with text, and/or graphics, or the like. In general, each input digital image includes image data for an array of pixels forming the image. The image data may include colorant values, such as grayscale values, for each of a set of color separations, such as L*a*b* or RGB, or be expressed in another other color space in which different colors can be represented. In general, “grayscale” refers to the optical density value of any single color channel, however expressed (L*a*b*, RGB, YCbCr, etc.). As will be appreciated, an image 32 may be cropped, enhanced, its resolution altered (e.g., reduced), or the like, and yet is still referred to herein as “the image.”

The term “color” as used herein is intended to broadly encompass any characteristic or combination of characteristics of the image pixels to be adjusted. For example, the “color” may be characterized by one, two, or all three of the red, green, and blue pixel coordinates in an RGB color space representation, or by one, two, or all three of the L, a, and b pixel coordinates in an Lab color space representation, or by one or both of the x and y coordinates of a CIE chromaticity representation, or so forth. Additionally or alternatively, the color may incorporate pixel characteristics such as intensity, hue, brightness, or so forth. The term “pixel” as used herein is intended to denote “picture element” and encompasses image elements of two-dimensional images.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference once more to FIG. 1, the exemplary method begins at S100. At S102, images 32 to be used in generation of the photobook 52 are input, e.g., by a user 78. The input images may be larger in number than the images in the generated photobook. The images 32 may be the user's own photographs, and/or those of others.

At S104, the user 78 may be asked to select one or more template design elements, such as one or more of: a theme(s) for the photobook (e.g., time of the year, such as spring, summer, fall, winter; specific event, such as birthday party, wedding, vacation, or the like; or combination thereof), color scheme, such as red or green, a style of the photobook, (traditional, contemporary, or the like), a layout(s) (e.g., number of images on a page), total (or maximum and/or minimum) number N of pages (i.e., number of pages containing images) in the photobook and/or a (maximum) number I of images for the photobook. If no number N (or I) is selected, a default maximum and/or minimum number may be automatically employed. Some or all of the other design elements not specified by the user may be automatically selected by the system 10.

The method includes an automatic image selection stage A and an automatic photobook creation stage B. The selection stage A may proceed as follows:

At S106, image quality of some or all of the input images 32 is assessed. The IQ assessment component 60 may assess one or more criteria relating to image quality such as image size, blur, structural noise, exposure, contrast, and the like. Images which do not meet the IQ criteria may be excluded from the pool. These criteria may be reassessed later, e.g., after saliency detection at S110. The image quality assessment criteria may change at a later stage, based, for example, on the image size allowed in the layout of the design template. Image assessment is used to identify a subset of the images in the set (i.e., fewer than all images in the set) when, for example, there are too many images to incorporate in the photobook. If this is not the case, step S106 can be omitted.

At S108, images may be categorized based on their semantic content. For example, IC component 62 assigns one or more categories to each image 32 remaining in the pool, from a predefined, finite set of semantic content-based categories.

At S110, saliency detection may be performed on the input/remaining images. For example, ROI component 64 detects a region of interest in an image 32 for potentially cropping the image in this step or later, during the photobook creation stage B.

At S112, near duplicate images may be detected e.g., by the ND component 66. In some embodiments, and one or more near duplicate images may be removed from the set 32. In other embodiments, near duplicates may be grouped together on a page or adjacent pages of the photobook for aesthetic reasons.

At S114, one or more album templates 54 and/or template design elements may be automatically selected. For example, the user may have selected, at S104, a layout element, such as number of images on a page, size of images, position of images, or the like and/or a style or theme for the photobook from a set of styles or themes. The remaining design elements for the page templates are then selected automatically by component 68 based on the user's selections and the information extracted from the candidate images. This step may occur later, in stage B. For example, templates/template elements may be selected and/or proposed to a user based on a group of the candidate images assigned to a given page.

The method then proceeds to the creation stage B.

At S116, images from subset C are automatically selected for the template(s) 54 to generate the number N of pages based on a set of selection criteria. In particular, the image assignment component 72 generates each page to optimize the criteria.

In the following steps, a design template (or elements thereof) is automatically selected, based on one or more of the images and user defined template elements. The selection of a design template may include one or more of the selection of fonts, borders, background images, background colors, font colors, image layout, and other design elements.

For example, at S118, background color(s) is/are selected. For example, the color selection component 74 selects a background or border color for a page based on the chromatic content of one or more of the images for a page or pair of matching pages in a double page spread. At S120, font colors may be selected, e.g., by color selection component 74.

At S122, the photobook may be validated by the user. For example, visualization component 76 generates a representation of the digital photobook 52 for display on the client device display device. As will be appreciated, the user may be able to review the photobook in a more interactive mode where each page or double page is presented for review as it is created.

At S124, in an interactive mode, images and/or layouts etc. may be customized by the user.

At S126, the validated digital photobook 52 is generated and output. The digital photobook 52 may be output to rendering device 56 for printing as a hardcopy photobook or sent in digital form to the user, e.g., in exchange for a payment by the user. At this stage, low resolution versions of the images may be replaced with high resolution versions.

The method ends at S128.

As will be appreciated, the steps of the method need not proceed in the order illustrated and the method may return to an earlier step, e.g., based on user interactions.

The method illustrated in FIG. 1 may be implemented in a computer program product that may be executed on a computer. The computer program product may comprise a non-transitory computer-readable recording medium on which a control program for implementing the method is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 1, can be used to implement the exemplary method.

Various aspects of the system and method will now be described in greater detail.

In the following, the term “optimization and similar phraseology are to be broadly construed as one of ordinary skill in the art would understand these terms. For example, these terms are not to be construed as being limited to the absolute optimum. For example greedy algorithms may be used for selection of images which attempt to optimize various criteria without requiring that every possible combination of images and/or criteria be evaluated, as disclosed, for example, in U.S. Pat. No. 7,711,211, incorporated by reference.

As can be seen from FIGS. 1 and 2, the exemplary image selection workflow A includes four main cascaded modules 60, 62, 64, 66, followed by three cascaded modules 72, 74, 76 for the photobook creation workflow B. User interaction in the overall workflow can be as limited as providing the input photos 32, optionally selecting the album template 54 (with some guidance from the image categorization system 62, if desired), and performing the final validation. In other embodiments, described below, the user may interact further with the system, although this can be discretionary.

Various methods are proposed for selection of a set of images from which the final image to page assignments are then made. Different selection criteria can be used in the reduction of the number of input images in stage A. These criteria may be applied progressively or in appropriate combinations. By way of example, some or all of the following selection criteria are contemplated.

1. Low quality images (typically blurred, overexposed or small images) are discarded (S106).

2. Redundant pixels are eliminated and only salient regions are preserved through the ROI component 64 (S110).

3. Images are clustered and near-duplicates may be eliminated (S112).

4. Appropriate colors for backgrounds, fonts, and/or borders for the page can then suggested to the user in the photobook creation workflow (S118, S120). Further details for each of these steps are now described.

### Template Selection (S104, S114)

Template selection can be automatic or at least partially based on user-selected design elements (S104). The template component 68 uses the user-selected template elements or parameters for defining them, to define/select one or more page templates at S114. A design template describes the layout and other elements of a page of a photobook and can be used for two or more pages of the photobook. The design elements include layout elements (how many images to a page, their size, shape, relative positions on the page, etc), a background color or pattern for the space between the images, a border color or pattern for a perimeter of the page, font style, font color, in some cases a page size and/or shape, such as square or rectangular, small, large, and so forth. In some embodiments, a number of different templates (e.g., varying by layout) layouts can be combined into a set, so that there is variety in the page layouts throughout the photobook and to allow for images of different orientations and sizes to be accommodated. The present system and method allows some or all of the design elements to be modified based on the group of images automatically assigned to a page.

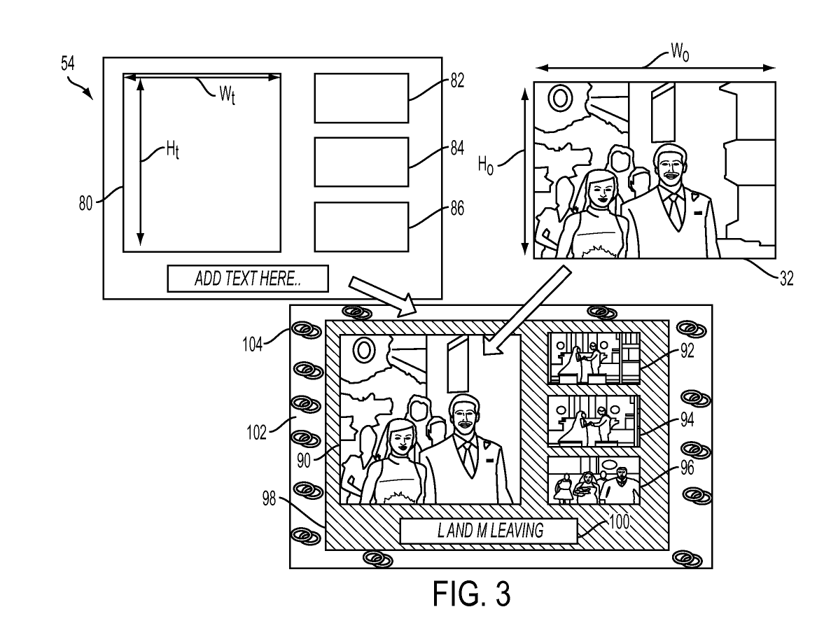

FIG. 3 illustrates an exemplary template 54. As will be appreciated, it is not necessary for every page of the photobook to use the same template. For example, a set of two, three, or more templates 54 may be grouped into a template collection to provide for different layout arrangements in a photobook. Each template includes a set of placeholders 80, 82, 84, 86, such as from 1-6 placeholders. The placeholders may be of different shapes and/or sizes, as shown in FIG. 3. Each placeholder can receive no more than one image 32. One of the placeholders 80 may be an anchor placeholder. This placeholder may be larger than other supporting placeholders 82, 84, 86 in the template. The anchor placeholder receives an anchor image 90 which is used in selecting the remaining images 92, 94, 96 for the placeholder. It may also be used in selection of a theme for the page, e.g., through image classification, image similarity, or the like. The supporting placeholders 82, 84, 86 may be automatically populated with cropped and/or uncropped images 90, 92, 94, 96, based on content/aesthetic features of the images. For example, an original image 32, having a height Hₒ and width Wₒ is cropped in one or both of these dimensions, based on the identification of a salient region of the image 32, to provide a cropped image 90 (less than the entire image 32) having a height and width Hₜ and width Wₜ of the placeholder 80. The resulting cropped image 90, which may be scaled to fit the placeholder 80, thus includes the salient region in whole or in part and excludes part of the image 32 which has been determined by the system to be less salient. With the addition of a background color region 98, selection of font color for a text area 100, and/or border region 102, the page 104 is complete. The background color(s) and/or border can be used to aid photograph selection or can be recolored based on the photographs assigned to the page 104.

In some embodiments, the user may, at S104, select one or more template elements for specific images. For example if a user has a set of birthday photos and a set of sporting photos to be used for the same photobook, the user may specify a different theme and/or other design elements for each set.

### Image Quality Assessment (S106)

In one embodiment, this step involves eliminating photos which do not fulfill predetermined minimum image quality requirements. One way of achieving this is to consider a set of features (or measures) for modeling aspects of image quality (such as size, blur, structural noise, exposure, and local contrast) and then using a simple assessment method based on a learning approach to determine the overall quality of the image. As will be appreciated, the method is not limited to any particular features or feature evaluation metric for determining image quality. The following features can be used, singly or in combination to assess image quality:

1. Size Feature (S)

Size is relevant in relation to the placeholder 80 in the template document 54. If the original image is too small in area for even the smallest placeholder in the templates 54, then it is already known that it will be unsuitable. A feature, S can evaluated based on a size ratio of the input image 32 to the placeholder 80 where the image will be inserted, e.g.:

$$S = \frac{{W}_{t} \cdot {H}_{t}}{{W}_{o} \cdot {H}_{o}} \qquad Eqn . 1$$

where Wₜ and Hₜ are the width and height of the target area in the final layout, and Wₒ and Hₒ are the width and height of the original image.

2. Blur Feature (B)

Blur destroys the fine details of an image. It can be caused by incorrect focus or by motion of the camera at shooting time. A blur feature as described in U.S. Pat. No. 5,363,209, incorporated herein by reference, can be used to detect out-of-focus images. The blur feature is computed by optionally converting the image into an appropriate color space, such as a luminance chrominance color space where the first dimension is the luminance value and the two other dimensions represent the chrominance values (e.g., YIQ). Then a derivative (sharpness) filter is applied which iteratively compares intensity signals over all or an area of the image to calculate a filter that transforms an idealized object of given sharpness to that of the target and produces an output signal indicative thereof. The global (average) amount of detail present in the image can then be quantified, as follows:

$$\begin{matrix}B = \frac{1}{N 1} {\sum }_{x , y} b ( x , y ) \\ where & Eqn . 2 \\ b ( x , y ) = max ( \vert i ( x , y ) - i ( x + k , y + l ) \vert ) \\ for ( k , l ) ∈ \{ ( 0 , - 1 ) , ( 0 , 1 ) , ( 1 , 0 ) , ( - 1 , 0 ) \} & Eqn . 3\end{matrix}$$

b(x, y) is a sharpness map indicating for each pixel (x, y) the amount of blur in its neighborhood; B is a scalar number, indicating the amount of blur within the entire image; and N1 is a normalization factor, depending on the size of the image (e.g., N1 is typically equal to the number of pixels in the image).

3. Structural Noise Feature (K)

Structural noise in the form of blocking artifacts resulting from image file compression is visible in homogeneous regions of images. This type of noise is particularly severe for images with high compression factors. To capture this type of degradation, standard computer vision algorithms for JPEGness detection can be used, such as the one described in Pere Obrador, “Content selection based on compositional image quality”, IS&T/SPIE 19th Annual Symp. on Electronic Imaging 2007. This algorithm can include the following steps:

1. Divide the image into a predefined number of blocks. Several schemes can be used to partition the image in blocks. In general, at least 8 blocks are used. Typically, the number of blocks can vary between 16 and 20 (such as 4×4 or 5×4). The dimensions of each block are determined based on the size of the original image in which the 16-20 blocks have to be fitted.

2. Compute, for two adjacent blocks (I and II), a signature based on pixel value histograms:

$$k ( I , II ) = {\sum }_{n} {H}_{I} ( n ) - {H}_{II} ( n ) \qquad Eqn . 4$$

3. Generate a histogram of the energy values calculated in the previous step for all adjacent pairs of blocks:

K=hist(k(i, j)) Eqn. 5

4. Exposure Feature (E)

Exposure measures the global amount of light in the image. Incorrect settings of the camera may cause under/over exposure of the image. In this case, the average brightness in the image can be evaluated, as follows:

$$\begin{matrix}E = \frac{1}{N 2} {\sum }_{x , y} e ( x , y ) \\ where & Eqn . 6 \\ e ( x , y ) = \frac{r ( x , y ) + g ( x , y ) + b ( x , y )}{3} & Eqn . 7\end{matrix}$$

and where r(x, y), g(x, y), b(x, y) are the values of the red, green and blue channel for pixel (x, y) and N2 is a normalization factor corresponding to the size of the image (e.g., in pixels).

Other methods of assessing exposure are disclosed in above-mentioned U.S. Pat. No. 5,414,538, incorporated herein by reference.

5. Local Contrast Feature (CM)

Local contrast measures the local distribution of light and shade within the image. For this reason, shadows and highlights can be quantified in the dynamic range of the image using typical computer vision measures, such as those described in Ilia Safonov, “Automatic Correction of Amateur Photos Damaged by Backlighting,” GRAPHICON 2006. In particular, the histogram of the brightness of the image H(i) can be computed and divided into three regions:

Shadows: brightness of [0, ⅓]

Midtones: brightness of [⅓, ⅔] and

Highlights: brightness of [⅔, 1],

where the digital value of the image pixels have been normalized to the [0, 1] range.

A number of features can then be calculated to characterize the local contrast of the image:

$${M}_{1} = {max}_{[ 0 , 1 / 3 ]} ( H ( i ) ) / {max}_{[ 0 , 1 ]} ( H ( i ) )$$

$${M}_{2} = {max}_{[ 1 / 3 , 2 / 3 ]} ( H ( i ) ) / {max}_{[ 0 , 1 ]} ( H ( i ) )$$

$${M}_{3} = {max}_{[ 2 / 3 , 1 ]} ( H ( i ) ) / {max}_{[ 0 , 1 ]} ( H ( i ) )$$

$${C}_{1} = {\sum }_{[ 0 , 1 / 3 ]} H ( i ) / {N}_{R}$$

$${C}_{2} = {\sum }_{[ 2 / 3 , 1 ]} H ( i ) / {N}_{R}$$

where N_{R} is the number of pixels in the particular region of calculation (i.e., shadows and highlights). All the values M₁, M₂, M₃, C₁, and C₂ above can be concatenated or otherwise aggregated to form a unique feature vector, CM.

Image Quality Assessment Strategy

After characterizing the quality of a given image using a set of image quality (IQ) features, such as the features [S, B, K, E, CM] described above, the features can be used to identify images of low/high image quality in the input image and/or to assign an image quality value from a range of IQ values. For example, all images below a threshold image quality can be identified, based on all the features.

In some embodiments, one of the following approaches can be employed to identify and discard images with poor quality:

1. A single classifier (e.g., a standard Fisher linear classifier) can be used which has been trained on a set of manually labeled training images 112 (e.g., labeled as bad/god image quality) and corresponding computed feature vectors (such as a single feature vector for each image which represents a set of image quality features, such as the concatenated feature vector CM). Given a new image, the classifier outputs an image quality e.g., a binary value representing “good” or “bad.” See, for example, Christopher Bishop, Pattern Recognition And Machine Learning, Springer Verlag (Jan. 1, 2006).

2. Two or more independent classifiers can be trained, e.g., one for each image quality feature (such as the five features M₁, M₂, M₃, C₁, and C₂ described above). As for the combined classifier, each classifier is trained with a set of training images 112 which have been manually labeled with an overall image quality value, however, in this case, the respective feature value is input for each training image. For a new image, the output scores of the (five) classifiers are combined, e.g., in a late fusion strategy.

In both approaches, the classification problem can be formulated as a binary classification problem with two categories, GOOD and BAD quality images. In one embodiment, all of the photos categorized as BAD are discarded. In other embodiments, there may be one or more conditions placed on the elimination of photographs. For example, if the user has specified that the photobook contains N at least images, then only the poorest quality images may be eliminated to ensure that there are still at least N images remaining in the set.

In some embodiments, a single feature can be determinative of low image quality. For example, if the Blur ratio S>θ, then IQ=0 (poor), where θ is a predetermined threshold.

As will be appreciated, the method is not limited to any specific image quality features. Other features which may be used in computing image quality are aesthetic features, as described, for example, in Ritendra Datta, et al., “Studying Aesthetics in Photographic Images Using a Computational Approach,” Lecture Notes in Computer Science, vol. 3953, Proc. European Conf. on Computer Vision, Part III, pp. 288-301, Graz, Austria, May 2006. Aesthetic features include features which are expected to contribute to whether an image is perceived to be of good or bad image quality. Even if the correlation with perception is fairly weak for some features individually, by assessing a number of different aesthetic features, a reasonable correlation can be achieved with human perceptions.

### Automatic Image Categorization (S108)

Image categorization can be performed on the input images 32 to help identify images with similar content that match a particular user-defined theme, such as spring, summer, winter, or fall. Alternatively, the user may want to group the photographs by other categories, such as photograph style (e.g., macro closeups), family member (e.g., child, dog, etc.), or location (e.g. backyard, grandmother's house), etc. This categorization process can be performed using a categorization system trained on manually labeled training images 112 and image signatures extracted from the training images based on low level features of the images. The categorization information can be used to guide subsequent steps in the workflow, such as image saliency detection (S110), near-duplicate selection (S112), and template selection (S114). As an example of the latter work step, images from a birthday party could be grouped together, and a photobook template with a “birthday” theme could be automatically suggested to the user.

The exemplary image signature is representative of a distribution of low level features of an image. Briefly, an exemplary method of computing an image signature can proceed as follows. Patches are extracted from the image e.g., at multiple scales. The patches can be extracted on a grid or based on regions of interest. Then, for each patch, low level features are extracted. As an example, two types of feature are extracted based on the pixels in the patch, such as color and gradient (e.g., SIFT) features are extracted. For each patch, a representation (e.g., a Fisher vector or histogram) may be generated, based on the extracted low level features. An image signature of the image is extracted, based on the patch representations. In the exemplary embodiment, the image signature is a vector (e.g., a Fisher vector-based Image Signature), which can be formed by a concatenation or other function of the patch-level Fisher vectors. Exemplary categorization systems of this type are described, for example, in Florent Perronnin, Yan Liu, “Modeling Images as Mixtures of Reference Images,” CVPR 2009 (Computer Vision Pattern Recognition), Miami, Fla., USA, Jun. 13-20, 2009, and U.S. Pub. No. 20100098343, collectively, “Perronnin and Liu 2010”; and in F. Perronnin and C. Dance, “Fisher kernel on visual vocabularies for image categorization,” In Proc. of the IEEE Conf. on Computer Vision and Pattern Recognition (CVPR), Minneapolis, Minn., USA. (June 2007) and U.S. Pub. No. 2007/0258648, collectively “Perronnin and Dance 2007”, which describe a Fisher kernel (FK) representation based on Fisher vectors, which is similar in many respects to the Fisher vector-based image signature described herein.

As an alternative to the Fisher vector-based image signature, a Bag-of-Visual words (BOV) representation of the image can be used as the image signature, as disclosed, for example, in above-mentioned U.S. Pub. Nos. 2007/0005356; 2007/0258648; 2008/0069456; the disclosures of which are incorporated herein by reference, and G. Csurka, C. Dance, L. Fan, J. Willamowski and C. Bray, “Visual Categorization with Bags of Keypoints,” ECCV Workshop on Statistical Learning in Computer Vision (2004); also the method of Y. Liu, D. S. Zhang, G. Lu, W.-Y. Ma, “A survey of content-based image retrieval with high-level semantics,” in Pattern Recognition, 40 (1) (2007).

The low level features which are extracted from the patches are typically quantitative values that summarize or characterize aspects of the respective patch, such as spatial frequency content, an average intensity, color characteristics (in the case of color images), gradient values, and/or other characteristic values. In some embodiments, at least about fifty low level features are extracted from each patch; however, the number of features that can be extracted is not limited to any particular number or type of features. For example, 1000 or 1 million low level features could be extracted depending on computational capabilities. In the exemplary embodiment, the low level features include local (e.g., pixel) color statistics, and texture. For color statistics, local RGB statistics (e.g., mean and standard deviation) may be computed. For texture, gradient orientations (representing a change in color) may be computed for each patch as a histogram (SIFT-like features). In the exemplary embodiment two (or more) types of low level features, such as color and texture, are separately extracted and the representation of the patch or image signature is based on a combination (e.g., a sum or a concatenation) of two Fisher Vectors, one for each feature type.

Scale Invariant Feature Transform (SIFT) descriptors (for patch representations) can be computed according to the method of Lowe, “Object Recognition From Local Scale-Invariant Features,” ICCV (International Conference on Computer Vision), 1999. SIFT descriptors are multi-image representations of an image neighborhood, such as Gaussian derivatives computed at, for example, eight orientation planes over a four-by-four grid of spatial locations, giving a 128-dimensional vector (that is, 128 features per features vector in these embodiments). Other descriptors or feature extraction algorithms may be employed to extract patch representations from the patches. Examples of some other suitable descriptors are set forth by K. Mikolajczyk and C. Schmid, in “A Performance Evaluation Of Local Descriptors,” Proceedings of the Conference on Computer Vision and Pattern Recognition (CVPR), Madison, Wis., USA, June 2003, which is incorporated in its entirety by reference.

Each patch can be characterized with a gradient vector derived from a generative probability model. In the exemplary embodiment, a visual vocabulary is built for each feature type using a probabilistic model, such as a Gaussian Mixture Model (GMM). Modeling the visual vocabulary in the feature space with a GMM may be performed according to the method described in F. Perronnin, C. Dance, G. Csurka and M. Bressan, “Adapted Vocabularies for Generic Visual Categorization,” In ECCV (2006). The GMM comprises a set of Gaussian functions (Gaussians), each having a mean and a covariance, where each Gaussian corresponds to a visual word. The patch can then be described by a probability distribution over the Gaussians. The GMM vocabulary can be trained using maximum likelihood estimation (MLE) considering all or a random subset the low level descriptors extracted from the labeled set of training images 112. Then, given a descriptor of a patch (patch representation), such as a color or texture feature vector, the probability that it was generated by the GMM is computed as a sum of weighted probabilities for each Gaussian.

Considering the gradient log-likelihood of each patch with respect to the parameters of the Gaussian Mixture leads to a high level representation of the patch which is referred to as a Fisher vector. The dimensionality of the Fisher vector can be reduced to a fixed value, such as 50 or 100 dimensions, using principal component analysis. In the exemplary embodiment, since there are two vocabularies, the two Fisher vectors are concatenated or otherwise combined to form a single high level representation of the patch having a fixed dimensionality.

As will be appreciated, the Fisher vector-based image signature is exemplary of types of high level representation which can be used herein. Other image signatures may alternatively be used, as discussed above, such as a Bag-of-Visual Words (BOV) representation or Fisher kernel (FK).

### Automatic Image Saliency Detection (S110)

Image saliency detection (or “thumbnailing”) involves the selection of one or more regions of interest (ROIs) in an input image 32. The detection can aid in magnifying or zooming on a desired subject area, or facilitating the rendering of the main subject, etc. Although current cameras typically provide users with options for focusing on the main subject and automatically composing the picture, cropping currently remains an operation which is performed manually, e.g., in a post-processing workflow, especially when users are asked to create photo albums. The present method allows automatic cropping of images, e.g., to meet the dimensions of a template place holder 92, and at the same time magnifying the image to focus on a salient region or regions which encompasses less than the entire image.

Briefly, the image thumbnailing process may include, for a target image 32, identifying and retrieving a set of the K most similar images to a target image that has passed the quality assessment (S106) and categorization (S108) steps. A simple classifier can then be built which is used to generate saliency maps. K can be, for example, at least 5 such as from 5-100, depending on the size of the database from which they are retrieved.

In the exemplary method the detection of salient regions is performed automatically using a previously annotated image database 112. The images in the database are manually annotated with salient regions. Thus, each pixel or each patch of the image can be assigned to a salient or non-salient class. Two image representations can then be generated for each training (database) image, which describe the distribution of low level features of the image e.g., as described for the image signatures in S108. However, in this case, one representation is generated based on the patches in the salient region(s) and the other is generated for the patches in the non-salient regions. The representations of the similar images can then be used to train a classifier for the detection of salient regions in the input image 32. Such a method is described, for example, in Perronnin and Yang 2010. In the exemplary embodiment, each input image 32 and each of the similar (K nearest neighbor) images is represented by a high level representation which is a concatenation of two Fisher Vectors, one for texture and one for color, each vector being based on the Fisher Vectors of the patches (e.g., as an average or concatenation). This single vector is referred to herein as a Fisher image signature. In other embodiments, the patch level Fisher vectors may be otherwise fused, e.g., by concatenation, dot product, or other combination of patch level Fisher vectors to produce an image level representation.

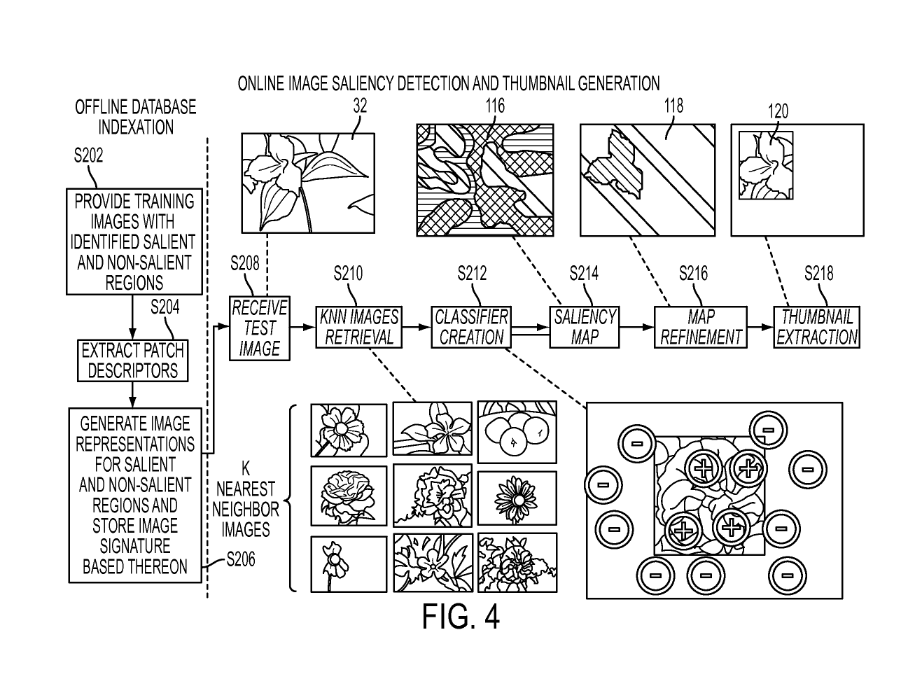

FIG. 4 illustrates an exemplary method for extracting a thumbnail from an image 32. The method includes an offline stage which can be performed prior to the start of the method shown in FIG. 1.

1. Off-Line Database Indexation

At S202, a set 112 of training images is provided in which a salient region (region of interest) or regions has/have been manually identified. Generally, only one such region is identified. For example, users draw a shape, such as a rectangle or other regular or irregular shape around the salient part(s) of the image. The system then builds a map of salient and non salient regions based on this information. The dataset 112 ideally includes a wide variety of images, including images which are similar in content to the image 32 for which a region of interest to be detected. For example, the dataset may include at least 100, e.g., at least 1000 images, such as at least about 10,000 images, and can be up to 100,000 or more, each dataset image having an established region of interest.

At S204, for each image in the database 112, local patches and associated low level descriptors (patch representations) are extracted. Patches can be extracted and descriptors (patch representations) generated in the same way as for the test image 32 (e.g., as described above for S108). Each extracted patch is also labeled as salient or non-salient according to its position with respect to the annotated region of interest defined at S202.

At S206, +ve and −ve image representations (e.g., Fisher image signatures) are generated based on the descriptors for the salient and non-salient patches, respectively. For example, in the low level feature space, a visual vocabulary is built. Then, +ve and −ve high level image representations are computed, based on the patch descriptors for the salient and non salient patches identified at S204. For each image in the dataset 112, an image representation (e.g., Fisher image signature) based on the +ve and −ve high level representations is stored. This ends the offline stage.

As will be appreciated, steps S202-S206 may be performed by a separate computing device and the image representations stored in database 112. Once the image representations have been computed and indexed, it is not necessary to store the actual images in the training set 112.

2. On-Line Saliency Detection and Thumbnail Generation

At S208, given a new image 32, an image representation is generated. The image representation can be computed in an analogous way as for the training images 112, except that all patches of the image are used to compute the image representation. For example, a high level representation of the image is generated as a sum of all the patch representations (see, Perronnin and Liu 2010, section 3.2, for further details on this step). In the exemplary embodiment, each image 32 is represented by a high level representation which is the concatenation of two Fisher Vectors, one for texture and one for color, each vector formed by averaging the Fisher Vectors of all the patches.

At S210, the K most similar images (KNN) are retrieved from the indexed database 112. This may be performed by comparing the high level representation of the image computed at S208 with the image representations of images in the database 112. For example, the subset of K-nearest neighbor images in the dataset 112 of pre-segmented images (i.e., fewer than all) is identified, by the ROI component 64, using a simple distance measure, such as the L₁ norm distance between the high level representation of the input image 32 and Fisher image signatures of each dataset image (e.g., as a sum of the high level +ve (salient) and −ve (non-salient) representations).

At S212 a saliency classifier 114 (FIG. 2) is generated, based on the K retrieved images, for classifying patches of the input image 32 as belonging to a salient regions or not, based on the patch representations. In one embodiment, the saliency classifier 114 includes two classifier models. Specifically, a salient (foreground) classifier model and a non-salient (background) model are computed based on the high level +ve and −ve representations of the K most similar images retrieved at S210, respectively. The salient classifier model is trained only on the +ve patch representations and the non-salient classifier model is trained only on the −ve patch representations. In other embodiments, a binary classifier 114 is trained using, as positive examples, the +ve (salient) representations of the salient regions of the retrieved K-nearest neighbor images (designated by a “+” in FIG. 4). As negative examples, −ve (non-salient) representations for the non-salient background regions are used (designated by a “−” in FIG. 4) are used. The same high level representations can be used by any binary classifier, or alternatively other local patch representations can be considered in another embodiment.

At S214, each image patch of the input image 32 is classified by the classifier 114 with respect to its saliency, based on its patch representation(s). In particular, each patch representation (e.g., as generated in S108) is input to the classifier and the output of the classifier is used to classify the patch as salient or non-salient (a binary decision) or to assign a probability of the patch being salient/non-salient. The result of the patch classification is propagated to the image pixels, generating a saliency map 116. In one embodiment, each pixel of a patch is assigned the probability of the patch in which it is located. In another embodiment, each pixel is assigned a weighted probability, e.g., based on Euclidian distance, of the probability of its most closely neighboring patches (e.g., the patch it is in and the 4 or 8 most closely adjacent patches).

Optionally, at S216, the map 116 is refined, e.g., with graph-cut segmentation, to generate a binary map 118.

At S218, a thumbnail region 120 can be extracted, based on the saliency map 116 or 118. For example a rectangular, or other-suitably shaped crop of the image is defined, based on the salient region e.g., by annotations such as HTML tags. As will be appreciated, this step may be performed at a later stage, e.g., once a placeholder 92 has been selected for the image, i.e., when the aspect ratio of the placeholder in which the image is to be located is known. In some cases, e.g., for an anchor image 90, the entire image 32, rather than a cropped image 120 may be used.

### Near Duplicates Identification/Removal (S112)

The number of redundant images can be decreased by applying a clustering technique (see, for example, Perronnin and Liu 2010). Redundancy may be introduced by the thumbnailing operation performed in S110 or it may be an intrinsic feature of the collection of images.

Several methods for determining similarity for computing redundancy and detection of near-duplicates are contemplated. For example, one or more types of similarity can be considered:

a. structural similarity

b. content similarity

c. aesthetic similarity

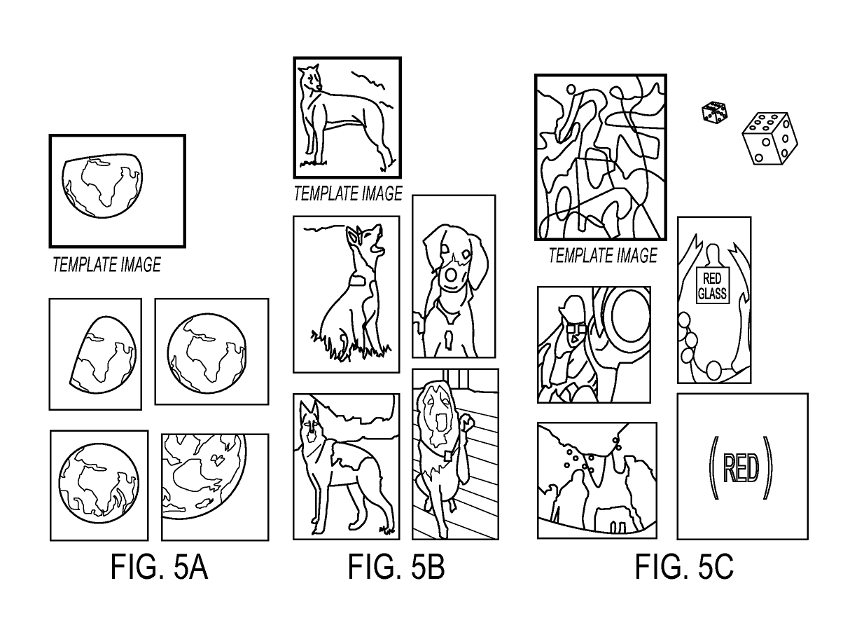

See, for example, the images shown in FIG. 5. In case (a), the images are considered similar if their visual content has a structural similarity. Thus, images of a ball and a globe may be structurally similar because they both have a similar geometric feature, in this case, they are primarily circular. Where there are a large number of images, mode detailed structure of the images may be considered. In case (b), the image semantic content, e.g., as output by categorizer 62 (here, presence of a dog) is what determines similarity. In the last case c), the color palette of the image is extracted and the content is completely neglected in computing similarity between images. In some embodiments, the presence/absence of other specific aesthetic elements like repetitive patterns, textures, etc., can also be considered for aesthetic similarity.

Depending on the type of similarity selected, different clustering strategies may be employed, e.g., combining more than one similarity criterion. Using this information, near duplicates can be identified, and either grouped together for aesthetic reasons (e.g., grouping a set of indoor photos from a party, vs. the outdoor images from the same party); or excluded from the initial auto-generated photobook (e.g. by selecting only the “best” image from a set of nearly identical images). This information can also be used to suggest alternate pictures for users to consider (i.e., at a later stage in the workflow), if they do not like the image that was auto-selected for a particular page in the photobook (e.g., selecting a different dog image, so that each image shows the same animal on different vacation trips).

Autoflow of Selected Images into Album Templates (B)

This stage in the workflow involves automatic insertion of the images selected and grouped in stage A into the album template(s)/template design elements selected by the user and/or system at S104, S114. Before insertion, the size of the input image may be compared with the size of the placeholder where the image will be inserted, to check whether or not its resolution is suitable.

In one embodiment, the user can select templates/design elements based on suggestions provided by the system (e.g., using the image category information provided by the image categorizer module), or by using his or her own personal preferences (e.g., one photograph per page versus two photos per page, etc.). The system can also auto-suggest appropriate borders or other clipart to enhance the photobook template, based on the information provided by the user and/or extracted by the categorizer.

Selection criteria for the final set of images to be placed in the photobook thus may include image quality assessment, image thumbnailing, near duplicate removal, as determined in stage A. Other grouping/selection techniques such as image clustering, user profiles, classification, color or palette matching, and the like may be used in stage A or B as a means to reduce further the number of images to be used in the photobook if there are still too many candidate images in the subset C after the first stage A and to group images to be presented together on a page. Methods for computing a user profile based on images in a user's collection (e.g., on asocial networking site) are disclosed, for example, in above-mentioned copending application Ser. No. 13/050,587. In the present system, the user profile may be accessed, if one has previously been generated, or newly-created, and used as a basis for identifying images that are likely to be of interest to the user because their semantic content (as output by the categorizer), matches a category which is prominent in the user profile. For example, if the user profile indicates the user is interested in cycling, the system may favor inclusion of one or more cycling photographs as candidate images for the collection.

In some embodiments, initially selected design elements in the design template can be adjusted through the automated selection of background colors, font colors, and other design elements to aesthetically compliment the content of the selected images. To provide better consistency between photos, color palettes are extracted from images and are used to harmonize the choice of photos within a page. Similarly, color palettes can also be used to harmonize other design elements (e.g., borders, fonts, background colors, and the like.).

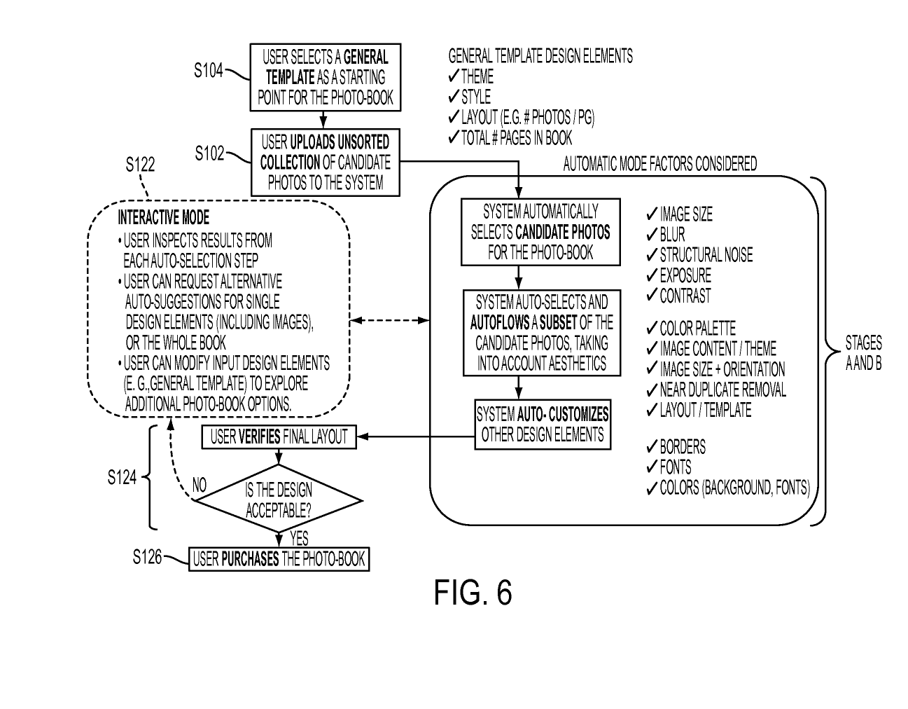

A color palette is a limited set of different colors, generally less than 30 colors, e.g., from 3-10 colors, which are representative of the colors of the pixels in the image. Methods for extracting color palettes are disclosed, for example, in the following copending applications, the disclosures of which are incorporated herein by reference, in their entireties: U.S. application Ser. No. 12/632,107, filed on Dec. 7, 2009, entitled SYSTEM AND METHOD FOR CLASSIFICATION AND SELECTION OF COLOR PALETTES, by Luca Marchesotti; U.S. application Ser. No. 12/890,049, filed on Sep. 24, 2010, entitled SYSTEM AND METHOD FOR IMAGE COLOR TRANSFER BASED ON TARGET CONCEPTS, by Sandra Skaff; et al., U.S. application Ser. No. 12/908,410, filed on Oct. 20, 2010, entitled CHROMATIC MATCHING GAME, by Luca Marchesotti, et al., and U.S. Pub No. 20090231355. The colors in a predefined color palette may have been selected by a graphic designer, or other skilled artisan working with color, to harmonize with each other, when used in various combinations. Each predefined color palette may have the same number (or different numbers) of visually distinguishable colors. These colors are often manually selected, in combination, to express a particular aesthetic concept. A color palette 106 (FIG. 6) can be extracted from an image 32, e.g. by fitting a Gaussian Mixture model of N Gaussians to the colors of the pixels in the image and using the N means of the Gaussians as the colors in the palette. Similar predefined color palettes can be identified by comparing the extracted color palette 106 of the image 32 in the set with a set of predefined color palettes to identify a subset of one or more of the most similar (i.e., fewer than all) predefined color palettes. This similar predefined color palette can then be used to define colors for the page template, such as complementary background, font, and/or border colors.

Color palettes can also be used to group images with similar colors. For example, a set of five colors is extracted from an image 32 in the set and compared with color palettes extracted from other images 32 in the set which have been assigned to the same category by the categorizer 62, or otherwise grouped e.g., by time frame and/or by the ND component, or the like. A set of images with similar palettes (e.g., as measured by computing the Earth mover distance or other similarity metric between the color palettes) is identified for grouping together these images on a page or two-page spread.

In one embodiment, the pool of input images output from stage A can be analyzed to determine a set of key photos to use as “anchor” photos (e.g., one for each page in the photobook or, alternatively, each double-page spread in the photobook), and also the supporting images that could be grouped with the anchor photograph to form a pleasing arrangement of photos (e.g., photos with similar image content, similar color palettes, similar frequency content (e.g., close-ups vs. city skylines), suitable aspect ratios, etc.)

As an example of the exemplary workflow stage B, suppose that a user requests a photobook with N pages, where each set of 2 pages (i.e., a double-page spread, where the two pages are viewable at the same time in the finished book) can contain from 2 to 6 photographs. The system can then look at the reduced set of images 32 output from stage A and select a set of N (or N/2) anchor images 90. These can include the top N images from the pool (e.g., based on image quality metrics identified at S106). Alternatively, if there are a large number of good photos, N photos can be selected randomly from the pool, or they can be selected based on time stamp information (e.g., one picture per hour of a wedding event), or they can be selected to maximize the dissimilarity between images (e.g., in the case of selecting 20 photos for an art portfolio), or a combination of selection methods.

The system can then select from one to five additional photos 92, 94, 96 per page to be placed near these anchor images 90. For example, the image assignment component 72 selects additional images that it determines will form an aesthetically pleasing group of images for a page or a double page spread, based on its knowledge of the color palette, image content, image size, frequency content, time stamp information (if relevant) etc. of both the anchor image and the supporting images 92, 94, 96. Also, while the supporting images in this example are chosen from the remaining images in the pool, they could alternatively or additionally be selected from the original set of anchor images, in which case, new anchor images could then be selected from the remaining pool of images C output from stage A.

Computed color palettes may also be presented to a user for selection of a background or border color or pattern for a page or may be used in automatic selection of one or both of these.

### Album Validation (S122)

Step S122 of the photobook creation workflow includes album validation, where the auto-generated photobook 52 is displayed to the user, who can then further customize the photobook, at S124, if desired.

### Customization Step (S124)

For example, if the user does not like one of the images that was automatically selected for a page, then the user may select a different image 32 in its place. Or, as noted earlier, the system could auto-suggest similar images, based on the analysis results from the image categorization and near-duplicate components 62, 66. FIG. 3, for example, illustrates a user interface in which images that are similar to an automatically selected one (according to one or more of the exemplary similarity criteria) are displayed to user for selection of a replacement image by a user. If the user clicks on a palettes tab 110, a set of palettes similar to the image palette 106 are displayed for selection of border/background/font colors.

In another embodiment, by re-running the ROI component 64, a different thumbnail option for the same image could be suggested to the user. Or, by using different results from the color selector 74, a different set of color schemes (e.g., background colors, design elements such as borders and/or fonts, etc.) could be suggested to the user. As will be appreciated, other types of modifications that a user can perform, or which can be proposed automatically to the user can be integrated into the exemplary workflow.

Unlike current workflows, which place the burden of image selection on the user, the exemplary workflow automatically selects the best images from a large collection of photos. The selection is based not only on image content, but also image aesthetics (such as image resolution, blur, and color palettes) and the user's input regarding design preferences (e.g., preferred template styles, desired themes, color preferences, and combinations thereof).

Consequently, given knowledge of the user's intent and preferences, (e.g., the user would like a square photobook of a child's birthday party, where the color theme of the party was pink and green), the workflow can then select images that best match this combination of criteria, modifying images where appropriate (e.g., auto-cropping images intelligently to fit a square aspect ratio), grouping images that would look good together, eliminating near duplicates as needed, and finally creating the most aesthetically pleasing arrangement of photos for the user.

In addition, the exemplary workflow can auto-select one or more design elements (such as fonts, borders, background colors, font colors, etc.) to enhance and harmonize the images in the photobook. For example, a set of photos from a child's birthday party where the children are gathered around a cake is automatically detected by the semantic categorizer. The group of photos could be placed together on a page and automatically enhanced with a border of pink and green birthday candles along the edge of the photobook. Alternatively, a different set of photos could be enhanced with a border of festive balloons, where the color of the balloons is selected to match the color palette of the images on the page.

Because each of these auto-selection steps can be inspected by the user, it allows users to easily explore other options (and thus alternative photobook features), by altering the automatic image selection criteria (such as color themes, or template layout) that were used by the system. For example, the system 10 automatically presents a generated photobook to the user. The user can inspect the results of each auto-selection step and ask the system to auto-suggest other alternatives for each step, such as alternate photos for the layouts, alternate background colors, or alternate design templates (e.g., using only two images per page instead of three), and so forth.

When the user asks the system to display alternative images for an image that the user rejects, the system can suggest one or more alternative images to the user. In one embodiment, these alternative images can be those that were closely ranked to the selected image, in terms of image quality. In another embodiment, these alternative images can be selected based upon running the selection criteria against the database of images with a slightly different set of user design elements. These may be chosen automatically by selecting a set of design elements that are in the neighborhood of the original set of design elements defined by the user. For example, the system may choose a new color scheme which is close to (or harmonious with) the original selected color, and use this modified criterion to suggest alternate images.

One embodiment of the user-defined interaction may be as follows: a user selects a target image in the photobook that he or she wants to change. The system displays a set of alternative images, e.g., as a filmstrip of image alternates adjacent to the target image. A roll-over mouse action on the images in the filmstrip by the user then drops the alternate image into the appropriate placeholder in the photobook layout, temporarily. This allows the user to see very easily and rapidly some alternate images for the selected image in the photobook. A subsequent mouse click then inserts the alternative image into the photobook layout permanently. Typical “keep changes”, “revert”, and “undo” types of controls can also be included in the interface.

A similar user interface where clicking a design element brings up a filmstrip displaying a set of suggested alternatives, etc. can also be used to preview alternate background colors, font colors, borders, layout arrangements, etc. This type of interaction enables users to view, verify, and modify (if desired) each page in the photobook, easily with very little effort.

The exemplary method can generate a photobook entirely without reference to metadata or other textual information. Thus, the user does not need to annotate the submitted photographs.

### Example Workflow

It may be noted that most photobook workflows currently follow one of two patterns. In the first type of workflow, users are required to perform all the photograph selection, photograph insertion, and design customization steps manually, by themselves. In the second type of workflow, an automated system is used to help the user by autoflowing all the photos into the photobook layout chosen by the user. However, in existing methods, no attempt is made to match non-image template elements, such as borders, font colors, background colors, and the like to the photographs chosen for a page. There is no consideration of whether less than a full image would be visually pleasing or whether near-duplicate images are present. Further, the templates are difficult to customize. For example, users cannot specify for sections of their photobook, nor can they specify the types of images to be included (e.g., high contrast images, bright images, non-blurry images, close-up macro images, etc.). In fact, current automated techniques often select blurry or low contrast images for the automatic layout.

By comparison, the exemplary workflow automates both the photograph insertion process and the photograph selection and design customization process. More specifically, each auto-selection step is completed by taking into account multiple factors, such as knowledge of the user's intent (e.g. themes, number of pages in the photobook, etc.) and preferences (e.g. preferred styles, layouts, color schemes, etc.). Images can be chosen to match the desired design template, or vice versa. By taking a holistic approach to the design problem, better and more aesthetically pleasing results can be obtained more quickly—and with less frustration—than with current workflows.

In the embodiment of FIG. 6, in one mode (automatic), the needed user interactions have been minimized. The system attends to the photo-selection, photograph insertion, and design customization steps automatically. Optionally, in an interactive mode, the user may query the system and ask the system to auto-suggest alternative images, and design elements, such as layouts, background colors, and the like. FIG. 6 illustrates some of the different design elements that can be customized in a photobook 52. A user interface is generated on the client device which allows the user to select design elements and easily see alternative choices for these elements. The user can preview the photobook before it is output. Suitable dialog boxes can be used for other steps in the workflow process, where simpler user input is appropriate. In the exemplary page 104 formed by filling the page template of FIG. 3, for example, images are selected according to the automated methods disclosed herein. Any of the design elements/images can be changed by the user and the auto-layout can be subsequently reverted to, if desired. For example, the user could change the main image 90 and ask for the three smaller supporting images 92, 94, 96 to be repopulated. For any of the supporting images, the user could choose a different crop from the one suggested by the auto-thumbnailing process if desired. Page themes, backgrounds, borders can be added/removed/changed by the user if desired (either at the template design stage or in the editing phase of refining the photobook)—and auto-population, image selection and layout features can be changed/reverted to by the user at any time. Population of such a template and potential post-editing of such a page illustrates the photograph selection, thumbnailing, photograph match, background/border match, image theme classification, background selection/recoloring and the like possible in the present system.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of generating a photobook comprising:
receiving a set of images;
with a processor:
automatically selecting a subset of the images as candidates for inclusion in a photobook;
automatically selecting at least one design element of a design template for the photobook based on information extracted from at least one of the images in the subset; and
automatically filling placeholders of the design template with images from the subset to form at least one page of a multipage photobook.

2. The method of claim 1, wherein the selection of an element of the design template comprises selection of at least one of the group consisting of font style, border, background images, background color, font color, image layout, combinations thereof.

3. The method of claim 1, wherein the automatic selecting of the subset of the images is based on at least one of image quality assessment criteria, image relevance criteria, and near-duplicate removal criteria.

4. The method of claim 3, wherein the image relevance criterion is based on at least one of:
a user-selected or automatically identified theme or color scheme of the design template;
a user profile; and
other images in the set of images.

5. The method of claim 3, wherein the image quality assessment criteria is based on a measurement, on at least a salient part of the image, of at least one of:
image size;
image blur;
structural noise;
image exposure; and
image contrast.

6. The method of claim 1, wherein the automatic selection of the subset of images is also based on at least one of a user-selected theme and a user-selected style for the photobook.

7. The method of claim 1, wherein the automatic selection includes categorizing images in the set by semantic category based on low level features extracted from the images and grouping images that are categorized in a same one of a finite set of semantic categories for filling the placeholders to form the page.

8. The method of claim 1, wherein the automatic selection of the subset of images comprises removing redundant images comprising identifying images which are near duplicates of each other and removing at least one of the near duplicates from consideration as a candidate image.

9. The method of claim 1, wherein the method further comprises providing for presenting a set of automatically identified similar images to a user as candidates for replacement of an automatically selected image when a user rejects the automatically-selected image.

10. The method of claim 1, wherein the method further comprises providing for presenting at least one selected color palette to a user as a candidate for replacement of at least one automatically selected design element design of a template for the page, the design element being selected from a border color, a border pattern, a background color, a background pattern, and a font color for the page, the color palette in the set being selected based on a computed similarity between the color palette and a color palette extracted from at least one image on the page.

11. The method of claim 1, wherein the automatic filling of placeholders of the design template comprises selecting an anchor image for a first placeholder on the page of the photobook and selection a set of supplementary images which complement the anchor image based on at least one of a similarity of a color palette extracted from a supplementary image to a color palette extracted from the anchor image, a relationship between a time stamp of the supplementary image and a time stamp of anchor image, a similarity of the semantic content of the anchor image and supplementary image based on representations of low level features extracted from patches of respective images.

12. The method of claim 1, wherein the method further includes computing a saliency map of a candidate image in the subset and automatically cropping the candidate image based on the saliency map.

13. The method of claim 12, wherein the computing of the saliency map comprises:
for each image in a dataset of images for which a region of interest has been established respectively, storing a dataset image representation based on features extracted from the training image;
for the candidate image for which a region of interest is to be detected:
generating a candidate image representation for the candidate image based on features extracted from the candidate image;
identifying a subset of similar images from the images in the dataset, the identified subset being based on a measure of similarity between the candidate image representation and respective dataset image representations;
training a classifier with information extracted from the established regions of interest of the subset of similar images;
with the trained classifier, classifying regions of the candidate images with respect to saliency; and
generating a saliency map based on the saliency classifications.

14. The method of claim 12, wherein the cropping is also based on a placeholder shape.

15. The method of claim 1, wherein the method comprises automatically filling multiple pages of the photobook, wherein images of a first page are similar to each other, based on a computed measure of at least one of structural similarity, semantic content similarity and aesthetic similarity, and images of a second page are similar to each other based on a computed measure of at least one of structural similarity, semantic content similarity and aesthetic similarity, and wherein the first and second pages differ in at least one automatically-selected design element, the automatically-selected design element being selected from a border color, a border pattern, a background color, a background pattern, and a font color for the page.

16. A system comprising memory which stores instructions for performing the method of claim 1 and a processor in communication with the memory for executing the instructions.

17. A computer program product comprising a non-transitory recording medium encoding instructions, which when executed by a computer, perform the method of claim 1.

18. A system for generating a photobook comprising:
a selection component for automatically selecting a subset of a set of images as candidates for inclusion in a photobook;
a template component for automatically selecting at least one design element of design template for the photobook based on information extracted from at least one of the images in the subset;
a creation component which automatically fills placeholders of the design template with images from the subset to form a multipage photobook; and
a processor which implements the selection component, template component, and creation component.

19. A workflow process comprising:
automatically selecting a subset of a set of input images based on at least one of a computation of image quality and a computation of near duplicate images;
automatically cropping at least some of images in the subset based on identification of a salient region of the respective image;
grouping similar images in the subset into groups based on a computation of at least one of structural similarity, content similarity, and aesthetic similarity;
automatically selecting at least one design element of design template for a page of a book based on information extracted from at least one of the images in one of the groups, the design element being selected from a border color, a border pattern, a background color, a background pattern, and a font color for the page; and
automatically filling placeholders of the design template with the group of images to form a page, wherein the process is implemented with a computer processor.

20. The method of claim 19, wherein the method further comprises providing for presenting a set of automatically identified similar images to a user as candidates for replacement of an automatically selected image when a user rejects the automatically-selected image.
